(19) United States
(12) Patent Application Publication
(10) Pub. No.: US 2016/0281589 A1
(43) Pub. Date: Sep. 29, 2016

(54) INTERNAL COMBUSTION ENGINE

(71) Applicant: TOYOTA JIDOSHA KABUSHIKI KAISHA, Toyota-shi (JP)

(72) Inventor: Takeshi ASHIZAWA, Yokohama-shi (JP)

(73) Assignee: TOYOTA JIDOSHA KABUSHIKI KAISHA, Toyota-shi (JP)

(21) Appl. No.: 15/011,890

(22) Filed: Feb. 1, 2016

(30) Foreign Application Priority Data
Mar. 23, 2015 (JP) 2015-060008

(51) Int. Cl. F02B 23/10; F02B 17/00; F02F 3/28

(52) U.S. Cl. CPC F02B 23/10; F02F 3/285; F02B 17/005; F02B 2023/106

(57) ABSTRACT

An internal combustion engine includes: a spark plug arranged in the upper wall face of the combustion chamber; an in-cylinder injection valve that, when stratified charge combustion operation is performed, injects fuel into the combustion chamber so that a fuel spray is carried to the periphery of the spark plug by a tumble flow; a piston having, in a crown surface thereof, a concave portion formed so as to extend in an orthogonal direction to the axis line of a piston pin hole, and so that the depth changes in the direction of the axis line; and a bias flow generation apparatus that, in a case where stratified charge combustion operation is performed with an ignition timing retardation, generates a bias in a flow of intake air inside an intake port so that intake air is guided towards the relatively deep part in the direction of the axis line.

### BACKGROUND

1. Technical Field

The present application relates to an internal combustion engine, and more particularly to an internal combustion engine in which stratified charge combustion operation is performed utilizing a tumble flow.

2. Background Art

In Japanese Patent Laid-Open No. 11-343855, an intake air control apparatus for an in-cylinder-injection-type spark-ignition internal combustion engine is disclosed that performs stratified charge combustion operation utilizing a tumble flow. The aforementioned intake air control apparatus includes gas flow strengthening means for strengthening the flow of intake air that is introduced into a combustion chamber. The gas flow strengthening means generates a bias in the flow of intake air so that intake air flows in from an intake port in a manner in which the flow of intake air is concentrated towards the vicinity of a spark plug.

### LIST OF RELATED ART

Following is a list of patent documents which the applicant has noticed as related arts of the present application.

### [Patent Document 1]

Japanese Patent Laid-Open No. 11-343855

### [Patent Document 2]

International Publication No. WO 2000/77361

### Technical Problem

In the case of performing stratified charge combustion operation utilizing a tumble flow that is generated inside a cylinder, if the tumble flow is formed so as to break up near the ignition timing, turbulence of the air-fuel mixture can be increased at the periphery of a spark plug to thereby improve the burning velocity. In an internal combustion engine in which a tumble flow is generated inside a cylinder, stratified charge combustion operation may be performed in a state in which the ignition timing is retarded by a large amount relative to the optimal ignition timing at, for example, the time of warming up a catalyst. The turbulence of an air-fuel mixture inside a cylinder attenuates as the crank angle advances before and after compression top dead center. To favorably stabilize stratified charge combustion that is accompanied by retardation of the ignition timing, it is desirable for the turbulence to be large at the retarded ignition timing.

### SUMMARY

The present application has been made to address the above-described problem, and an object of the present application is to provide an internal combustion engine that can favorably stabilize stratified charge combustion that is accompanied by retardation of the ignition timing.

An internal combustion engine in which a tumble flow is generated inside a combustion chamber includes a spark plug, an in-cylinder injection valve, a piston and a bias flow generation apparatus. The spark plug is arranged in an upper wall face of the combustion chamber. The in-cylinder injection valve is configured, when stratified charge combustion operation is performed, to inject fuel into the combustion chamber so that a fuel spray is carried to a periphery of the spark plug by a tumble flow. The piston has, in a crown surface thereof, a concave portion that is formed so as to extend in an orthogonal direction to an axis line of a piston pin hole and so that a depth of the concave portion changes in a direction of the axis line. The bias flow generation apparatus is configured, in a case where stratified charge combustion operation is performed in a state in which an ignition timing is retarded relative to an optimal ignition timing, to generate a bias in a flow of intake air inside an intake port so that intake air is guided towards a part at which the depth is relatively deep in the direction of the axis line inside the concave portion.

The concave portion may be formed so as to be deepest at a center portion of the crown surface in the direction of the axis line.

The bias flow generation apparatus may include an air flow control valve that is configured, when in a closed state, to generate a bias in a flow of intake air inside the intake port so that intake air is guided towards the part of the concave portion. Also, the bias flow generation apparatus may be configured to close the air flow control valve in a case where stratified charge combustion operation is performed in a state in which an ignition timing is retarded relative to an optimal ignition timing, and to open the air flow control valve in a case where stratified charge combustion operation is performed in a state in which an ignition timing is controlled to an optimal ignition timing.

According to the present application, in a case where stratified charge combustion operation is performed in a state in which the ignition timing is retarded relative to the optimal ignition timing, a bias is generated in a flow of intake air inside an intake port so that the intake air is guided towards a relatively deep part inside a concave portion by a bias flow generation apparatus. By this means, in this case, since a tumble flow rotates using a relatively deep part inside a concave portion, the timing at which breakup of the tumble flow proceeds is delayed. As a result, generation of turbulence that accompanies breakup of the tumble flow is continued until a later time. Therefore, according to the present application, stratified charge combustion that is accompanied by retardation of the ignition timing can be favorably stabilized.

Further, according to the present application, in a case where a concave portion is formed so as to be deepest at a center portion in a crown surface in the direction of the axis line of a piston pin hole, a tumble flow rotates in the widest space in a combustion chamber. Consequently, the timing at which breakup of the tumble flow proceeds can be delayed more favorably.

### BRIEF DESCRIPTION OF THE DRAWINGS

FIG. 1 is a schematic diagram for describing the system configuration of an internal combustion engine according to a first embodiment of the present application;

FIG. 2 is a schematic diagram for describing a technique for realizing stratified charge combustion that is used in the first embodiment of the present application;

FIG. 3 is a perspective view that schematically illustrates the configuration around a piston and an intake port;

FIG. 4 is a view of a crown surface of the piston as seen from above in an axis line direction of a cylinder;

FIG. 5 illustrates a transverse section of outer grooves and an inner groove;

FIG. 6 illustrates a longitudinal sectional view of the outer groove and the inner groove, respectively;

FIG. 7 is a view for describing the specific configuration of an air flow control valve;

FIG. 8 is a view for describing a change in the flow of intake air inside the intake port that accompanies an opening/closing operation of the air flow control valve;

FIG. 9 is a view for describing a known technique for strengthening the turbulence of an air-fuel mixture;

FIG. 10 is a view that represents a relation between a groove depth in a piston crown surface and an in-cylinder mean turbulence;

FIG. 11 is a flowchart that illustrates a flow of control according to the first embodiment of the present application;

FIG. 12 is a view for describing a characteristic whereby turbulence in an air-fuel mixture that is obtained by the control according to the first embodiment of the present application is generated;

FIG. 13 is a transverse sectional view of a piston for describing a first modification of the concave portion in the present application;

FIG. 14 is a transverse sectional view of a piston for describing a second modification of the concave portion in the present application;

FIG. 15 is a transverse sectional view of a piston for describing a third modification of the concave portion in the present application;

FIG. 16 is a transverse sectional view of a piston for describing a fourth modification of the concave portion in the present application; and

FIG. 17 is a view that illustrates the manner in which a reverse tumble flow that descends on the intake side and ascends on the exhaust side is generated inside a combustion chamber.

### DETAILED DESCRIPTION

### First Embodiment

### Configuration of First Embodiment

### Overall Configuration of Internal Combustion Engine

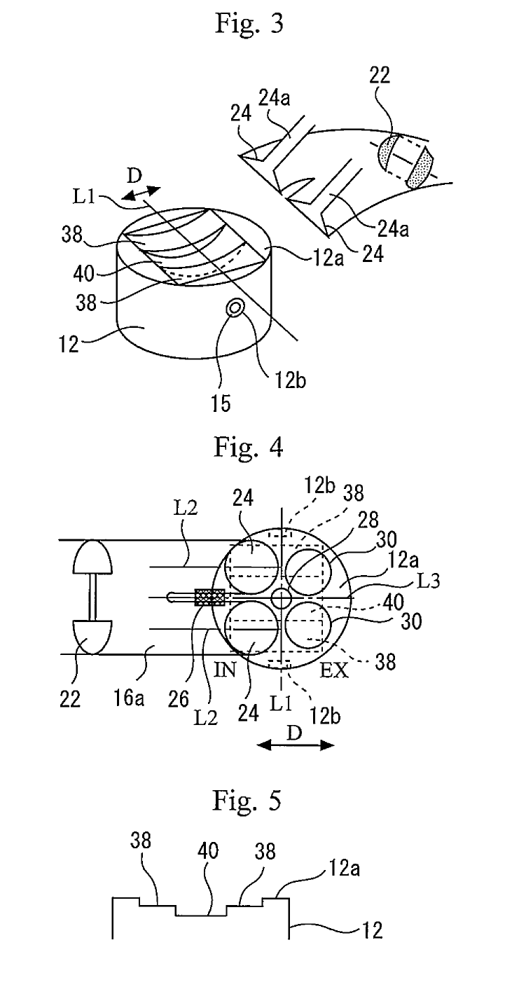

FIG. 1 is a schematic diagram for describing the system configuration of an internal combustion engine 10 according to a first embodiment of the present application. The system of the present embodiment includes a spark-ignition-type internal combustion engine 10. A piston 12 is provided in each cylinder of the internal combustion engine 10. The detailed configuration of a crown surface 12a of the piston 12 will be described later referring to FIG. 3 through FIG. 6. A combustion chamber 14 is formed on the top side of the piston 12 inside each cylinder. An intake passage 16 and an exhaust passage 18 communicate with the combustion chamber 14.

An electronically controlled throttle valve 20 is provided in the intake passage 16. The throttle valve 20 can adjust an intake air flow rate by the opening degree of the throttle valve 20 being adjusted in accordance with an accelerator position. An electronically controlled air flow control valve 22 is arranged at a position that is on a downstream side relative to the throttle valve 20 in the intake passage 16. The detailed configuration of the air flow control valve 22 is described later with reference to FIG. 3, FIG. 4 and FIG. 7.

An intake port 16a that is a site in the intake passage 16 at which the intake passage 16 is connected to the combustion chamber 14 is formed so as to generate a vertically rotating vortex, that is, a tumble flow, inside the combustion chamber 14 by the flow of intake air. Intake valves 24, each of which opens and closes the intake port 16a, are provided in the intake port 16a. As shown in FIG. 3 and the like that are described later, in each cylinder, two intake valves 24 are provided so as to be adjacent along the direction of the axis line L1 (see FIG. 4).

An in-cylinder injection valve 26 that directly injects fuel into the combustion chamber 14 is provided in each cylinder of the internal combustion engine 10. A spark plug 28 of an ignition device (not illustrated in the drawings) for igniting an air-fuel mixture is also provided in each cylinder. The spark plug 28 is arranged in an upper wall face (that is, a wall face on a cylinder head side) (in the configuration illustrated in FIG. 1, as one example, at a center portion of the upper wall face) of the combustion chamber 14.

An exhaust port 18a of the exhaust passage 18 is provided with exhaust valves 30, each of which opens and closes the exhaust port 18a. An exhaust gas purification catalyst 32 for purifying exhaust gas is installed in the exhaust passage 18. In addition, a crank angle sensor 34 for detecting a crank angle and an engine speed is installed in the internal combustion engine 10.

The system illustrated in FIG. 1 also includes an electronic control unit (ECU) 36. The ECU 36 includes an input/output interface, a memory, and a central processing unit (CPU). The input/output interface is configured to take in sensor signals from various sensors installed in the internal combustion engine 10 or the vehicle in which the internal combustion engine 10 is mounted, and to also output actuating signals to various actuators for controlling the internal combustion engine 10. Various control programs and maps and the like for controlling the internal combustion engine 10 are stored in the memory. The CPU reads out a control program or the like from the memory and executes the control program or the like, and generates actuating signals for the various actuators based on sensor signals that are taken in. The sensors from which the ECU 36 takes in signals include various sensors for acquiring the engine operating state such as the aforementioned crank angle sensor 34, and an accelerator position sensor 37 for detecting a depression amount (accelerator position) of an accelerator pedal of the vehicle in which the internal combustion engine 10 is mounted. The actuators to which the ECU 36 outputs actuating signals include the aforementioned throttle valve 20, air flow control valve 22 and in-cylinder injection valve 26 as well as the aforementioned ignition device.

### (Stratified Charge Combustion Utilizing Tumble Flow)

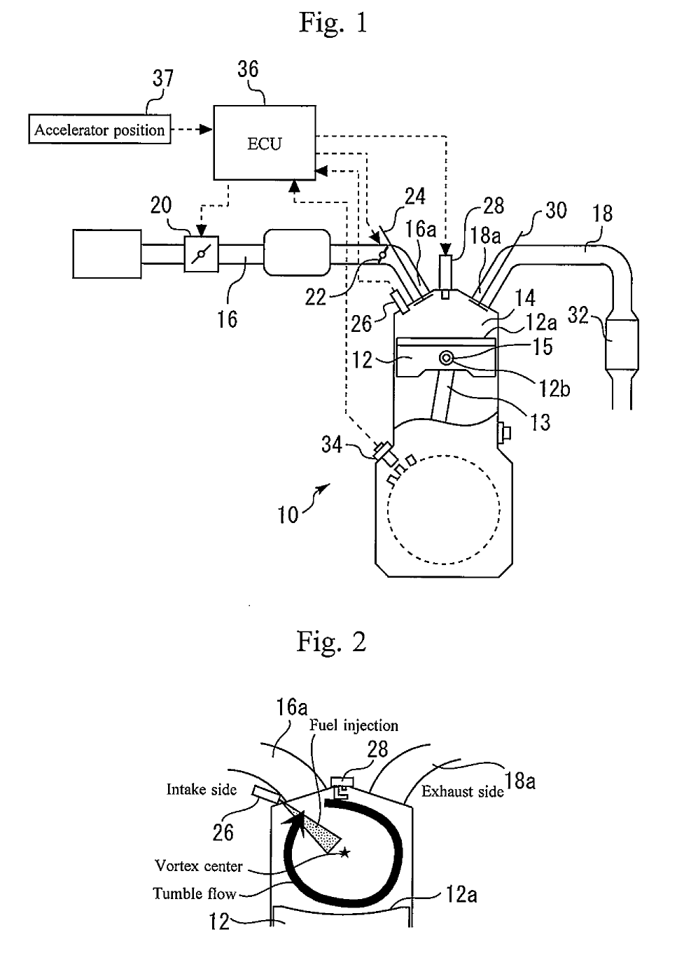

FIG. 2 is a schematic diagram for describing a technique for realizing stratified charge combustion that is used in the first embodiment of the present application. As described above, by selecting the shape of the intake port 16a in advance, the internal combustion engine 10 is configured so that a tumble flow is generated inside the combustion chamber 14. More specifically, a tumble flow that is generated in the present embodiment is, as illustrated in FIG. 2, a forward tumble flow that ascends on the intake side and descends on the exhaust side.

In the present embodiment, in order to realize stratified charge combustion, an air guide method is used that utilizes the tumble flow, more specifically, a method is used that transports a fuel spray to the periphery of the spark plug 28 by means of the tumble flow. The term “stratified charge combustion” refers to combustion that is performed by forming, in the vicinity of the spark plug 28 at the ignition timing, an air-fuel mixture layer for which the air-fuel ratio is richer than on the outside thereof. Note that FIG. 2 illustrates a state in the vicinity of 90° CA before compression top dead center (compression TDC).

To enable the performance of stratified charge combustion using the air guide method, the injection angle of the in-cylinder injection valve 26 is set so that the in-cylinder injection valve 26 can inject fuel towards the vortex center of the tumble flow at a predetermined timing in the middle period of the compression stroke. The term “middle period of the compression stroke” used here is preferably 120 to 60° CA before compression TDC. As one example, the predetermined timing used here is taken as 90° CA before compression TDC.

Divided injection is used as the fuel injection when performing stratified charge combustion. Divided injection is a technique in which the amount of fuel that should be injected during a single cycle is divided into a plurality of fuel injection amounts, and the respective fuel injection amounts are injected over a plurality of fuel injection operations. As one example, halved fuel injection is used here in which an initial fuel injection is performed during the intake stroke, and a second fuel injection is performed at the aforementioned predetermined timing (90° CA before compression TDC). The initial fuel injection is the main fuel injection, and the main part of the amount of fuel that should be injected during a single cycle is injected by this initial fuel injection. The second fuel injection is injection of a small amount of fuel that is required for stratification.

By performing the aforementioned second fuel injection with an appropriate spray penetration force, the fuel spray becomes wrapped by the tumble flow. The fuel spray that is wrapped by the tumble flow is carried to the periphery of the spark plug 28 as a result of the ascent of the piston 12. By this means, gas inside the cylinder can be stratified so that an air-fuel mixture layer that is in the vicinity of the spark plug 28 at the ignition timing is an air-fuel mixture layer for which the air-fuel ratio is richer than on the outside thereof.

Note that, in FIG. 2, a state when the air flow control valve 22 is opened fully is illustrated as one example. The air flow control valve 22 is closed fully when performing catalyst warm-up control as described later, and is opened fully when such a catalyst warm-up control is not performed. The basic idea for realizing stratified charge combustion with respect to a time when the air flow control valve 22 is closed for catalyst warm-up control is the same as that described above. Further, the method described with reference to FIG. 2 is an air guide method that is based on the idea that a fuel spray that is wrapped by a tumble flow is transported by the tumble flow. However, as long as a fuel spray can be carried to the periphery of a spark plug by a tumble flow, an air guide method that is an object of the present application is not limited to the method based on the above described idea. That is, for example, an air guide method may also be used that is based on the idea of allowing a fuel spray to be carried towards a spark plug together with a tumble flow by injecting a small amount of fuel so as to travel in a direction that faces a tumble flow that is ascending towards a fuel injection valve.

### (Specific Configuration of Crown Surface of Piston and Air Flow Control Valve)

FIG. 3 is a perspective view that schematically illustrates the configuration around the piston 12 and the intake port 16a. FIG. 4 is a view of the crown surface 12a of the piston 12 as seen from above in an axis line direction of the cylinder. As shown in FIG. 3, a piston pin hole 12b for receiving insertion of a piston pin 15 for coupling the piston 12 and a connecting rod 13 is formed in the piston 12. The direction of the axis line L1 of the piston pin hole 12b is parallel to the axis line direction of a crankshaft that is not illustrated in the drawings.

Two outer grooves 38 and one inner groove 40 are formed as grooves that have differing depths in the crown surface 12a of the piston 12. The inner groove 40 is provided on the center side in the direction of the axis line L1 (in this example, on the inner side of center lines L2 of respective valve stems 24a of the two intake valves 24). The outer grooves 38 are provided adjacent to the two sides of the inner groove 40 in the direction of the axis line L1. The inner groove 40 and outer grooves 38 are formed so as to extend in an orthogonal direction D with respect to the axis line L1. The orthogonal direction D is, more specifically, a direction that is orthogonal to the axis line L1 when the axis line L1 is seen from the direction of the axis line of the cylinder. Note that, the term “formed so as to extend in an orthogonal direction D” used here does not require that the relevant grooves extend exactly in a straight line in the orthogonal direction D, and for example also includes a groove that extends substantially in the orthogonal direction D, as in the case of a groove that extends in a direction that inclines slightly relative to the orthogonal direction D. Further, as long as a groove is based on the foregoing idea, it is not necessary for the width thereof to be strictly fixed.

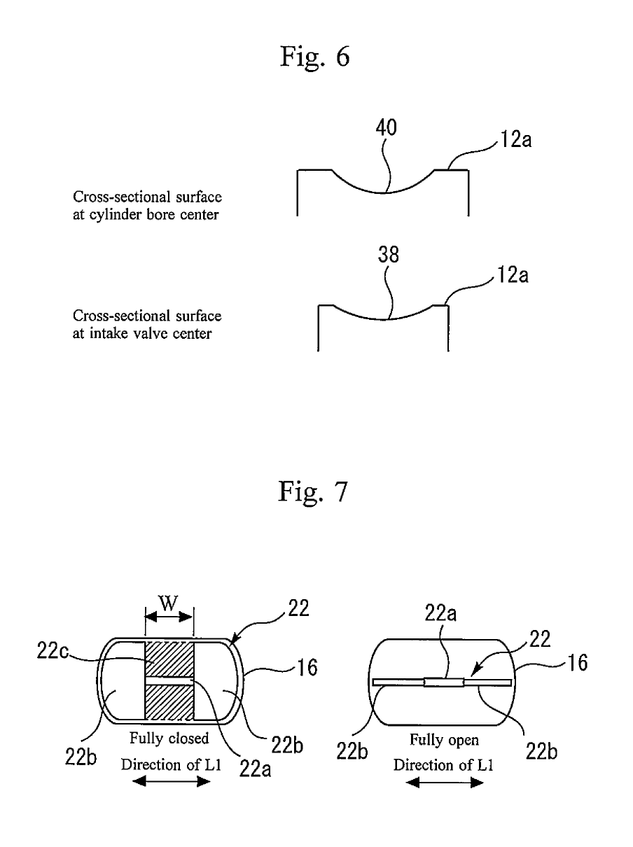

FIG. 5 illustrates a transverse section of the outer grooves 38 and the inner groove 40. FIG. 6 illustrates a longitudinal sectional view of the outer groove 38 and the inner groove 40, respectively. More specifically, FIG. 5 corresponds to a cross-sectional view in which the piston 12 is cut at the axis line L1 of the piston pin hole 12b. FIG. 6 corresponds to cross-sectional views in which the piston 12 is cut at a center line L3 of a cylinder bore that is parallel with the orthogonal direction D to the axis line L1, and a center line L2 of the intake valve 24 that is a direction parallel to the orthogonal direction D to the axis line L1, respectively.

As shown in FIG. 5 and FIG. 6, the inner groove 40 is formed so as to be deeper than the outer grooves 38 that are positioned at the two sides thereof. In this example, the inner groove 40 and outer grooves 38 are each formed as grooves having a constant curvature. The curvature of the inner groove 40 is formed so as to be greater than the curvature of the outer grooves 38.

In contrast, as shown in FIG. 3 and the like, the air flow control valve 22 is arranged in the intake passage 16 at a position that is further on the upstream side than a merging portion of the intake port 16a that branches into two parts. FIG. 7 is a view for describing the specific configuration of the air flow control valve 22. FIG. 7 shows the air flow control valve 22 seen from the downstream side of the flow of intake air. The air flow control valve 22 is a butterfly-type valve that makes the flow path area of the intake passage 16 variable.

As shown in FIG. 4, a valve stem 22a of the air flow control valve 22 is made parallel to the axis line L1. In a valve element 22b of the air flow control valve 22, a center portion in the direction of the axis line L1 is notched over the entire area thereof, and therefore the valve element 22b is fixed to the valve stem 22a in a form in which the valve element 22b is split into two at the two end sides in the direction of the axis line L1. According to the air flow control valve 22 configured in this manner, as shown in FIG. 7, while the air flow control valve 22 completely opens the intake passage 16 when the air flow control valve 22 is in a fully open state, the center portion in the direction of the axis line L1 also stays opened when the air flow control valve 22 is in a fully closed state. Hereunder, for convenience, the aforementioned center portion that does not block the intake passage 16 regardless of the opening degree as described above is referred to as “non-blocking portion 22c” of the air flow control valve 22.

A position at which the non-blocking portion 22c is provided in the air flow control valve 22 corresponds to, with regard to the flow of intake air, the relatively deep inner groove 40 among the grooves formed in the crown surface 12a of the piston 12. Therefore, the width w of the non-blocking portion 22c is made equal to the width of the inner groove 40, although the widths need not be exactly the same.

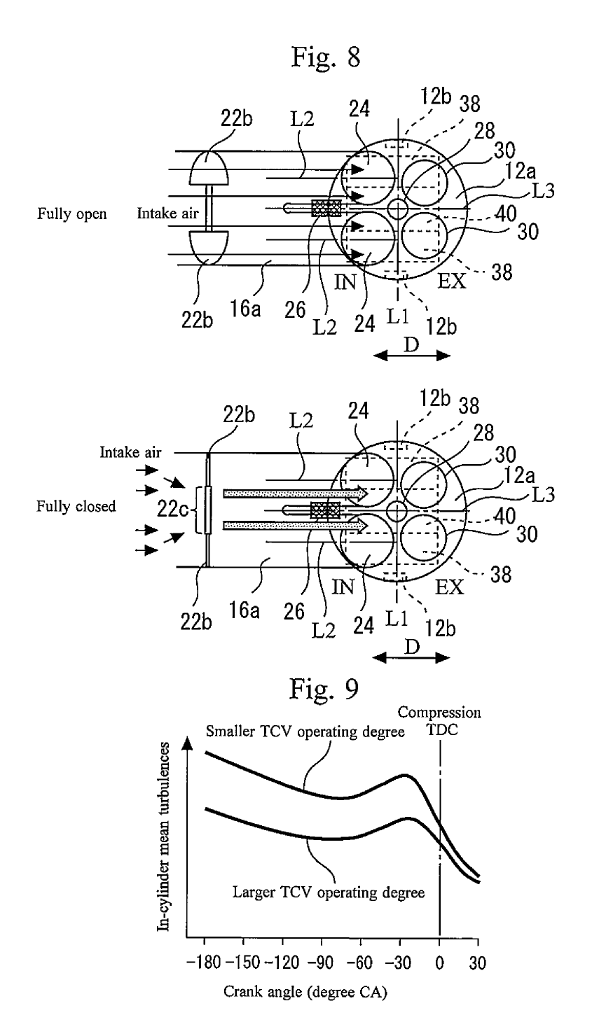

FIG. 8 is a view for describing a change in the flow of intake air inside the intake port 16a that accompanies an opening/closing operation of the air flow control valve 22. As shown in FIG. 8, in a case where the air flow control valve 22 is in a fully open state, intake air flows into the combustion chamber 14 without a bias being generated in the flow by the presence of the air flow control valve 22.

On the other hand, in a case where the air flow control valve 22 is in a fully closed state, bias is imparted to the flow of intake air by the presence of the air flow control valve 22 in a manner such that intake air passes through only the non-blocking portion 22c on the center side that does not block the intake passage 16. More specifically, in this case, as shown in FIG. 8, with respect to the flow of intake air inside the intake port 16a, a bias can be generated by the air flow control valve 22 so that air is guided towards the relatively deep inner groove 40 among the grooves formed in the crown surface 12a. In other words, by means of the air flow control valve 22, a bias can be generated in the flow of intake air inside the intake port 16a so that intake air flows into the combustion chamber 14 in a form in which the intake air is concentrated in the direction of the inner groove 40.

### (Combination of Catalyst Warm-Up Control by Retardation of Ignition Timing and Stratified Charge Combustion)

In the present embodiment, catalyst warm-up control by retardation of the ignition timing is performed when the temperature of the exhaust gas purification catalyst 32 is lower than a predetermined activation temperature (basically, at a time of fast idle operation after a cold startup). More specifically, the catalyst warm-up control is control that retards the ignition timing by a large amount relative to the optimal ignition timing (MBT (minimum spark advance for best torque) ignition timing), to thereby raise the exhaust gas temperature for the purpose of activating the exhaust gas purification catalyst 32 at an early stage. Note that fast idle operation is performed immediately after a cold start-up or the like of the internal combustion engine 10 in order to maintain the idle speed at a higher speed than the normal idle speed used after warming up ends.

The ignition timing during non-catalyst warm-up operation when the present control is not performed (that is, during normal operation) is set as an ignition timing that is targeted at the optimal ignition timing. The optimal ignition timing varies in accordance with the operating state of the internal combustion engine 10 (mainly, the engine load factor and engine speed). Accordingly, the ignition timing during non-catalyst warm-up operation is set in a predetermined crank angle range (for example, as shown in FIG. 9 and the like that are described later, a crank angle range in the vicinity of 30° CA before compression TDC) R1 that is before compression TDC. In contrast, the ignition timing during execution of catalyst warm-up control is significantly retarded compared to a value during normal operation that is targeted at the optimal ignition timing. More specifically, the ignition timing at such a time is set to a timing that is after compression TDC, for example, as shown FIG. 9 and the like, the ignition timing is set in a crank angle range R2 in the vicinity of 15° CA after compression TDC. Note that, in FIG. 9 and the like, the reason the usage range of the ignition timing during execution of catalyst warm-up control is narrower in comparison to the usage range thereof at a time of non-catalyst warm-up operation is that, with respect to the operating state in which catalyst warm-up control is performed in the present embodiment, an operating state that is taken as an object for the catalyst warm-up control is limited (that is, a fast idle state) in comparison to an operating state in which non-catalyst warm-up operation is performed.

### [Issue Related to Execution of Stratified Charge Combustion]

In the present embodiment, at a time of fast idle operation in which catalyst warm-up control is performed, stratified charge combustion is carried out utilizing the aforementioned air guide method. If stratified charge combustion is performed at a time of fast idle, an air-fuel mixture layer having a higher fuel concentration than on the outside thereof can be generated in the vicinity of the spark plug 28 without significantly enriching the air-fuel ratio, and hence combustion after a cold startup can be stabilized while achieving a decrease in fuel consumption.

In addition, to ensure that stratified charge combustion can be stably performed utilizing the air guide method, it is desirable to effectively utilize turbulence of the air-fuel mixture inside a cylinder. A single tumble flow that is generated inside a cylinder breaks up as a result of being pressed and contracted in the vicinity of compression TDC by the ascending piston 12, and becomes a collection of small vortexes. As a result, the turbulence of the air-fuel mixture in the cylinder becomes stronger. If the turbulence becomes stronger near the ignition timing, the combustion will be favorable (that is, the burning velocity will improve). The reason is that, because the turbulence becomes stronger, the surface area of a flame front that is the boundary of a flame that spreads (propagates) from the periphery of the spark plug 28 increases. Consequently, to ensure the stability of stratified charge combustion that utilizes the air guide method, it is important to strengthen the turbulence of the air-fuel mixture near the ignition timing.

Note that, in addition to the above-described air guide method, a wall guide method is also known as a method for realizing stratified charge combustion. The wall guide method is based on the idea of spraying fuel towards a cavity formed in the crown surface of a piston to thereby utilize the cavity to accumulate a fuel spray and transport the fuel spray to the periphery of a spark plug. When utilizing the wall guide method it is necessary to suppress the occurrence of a situation in which the fuel spray is dispersed by a tumble flow, and hence it is required to suppress the generation of a tumble flow as much as possible. Thus, the wall guide method is a technique for realizing stratified charge combustion based on a different idea than the air guide method that actively utilizes a tumble flow for stratification.

As described above, the usage range of the ignition timing differs greatly between a time of catalyst warm-up operation in which catalyst warm-up control is executed and a time of non-catalyst warm-up operation. In order to stabilize stratified charge combustion during both of these kinds of operation, it is required to strengthen the turbulence of the air-fuel mixture near the ignition timing for each kind of operation. However, a basic characteristic of the turbulence of an air-fuel mixture inside a cylinder is that the turbulence attenuates as the crank angle advances before and after the compression top dead center (for example, see FIG. 9 that is described hereunder).

FIG. 9 is a view for describing a known technique for strengthening the turbulence of an air-fuel mixture. FIG. 9 shows results obtained by simulating in-cylinder mean turbulences (mean turbulence strength inside a cylinder) in accordance with the opening degree of a TCV (tumble control valve) under the same operating conditions. The TCV is a valve that is arranged in the intake passage and that is used to make the strength (tumble ratio) of a tumble flow variable. When the TCV opening degree is made small, a bias flow that is imparted to intake air inside the intake port increases and the tumble flow becomes stronger. As shown in FIG. 9, by making the TCV opening degree small to strengthen the tumble flow, in comparison to a case where the TCV opening degree is relatively large, the turbulence of the air-fuel mixture can be strengthened irrespective of the crank angle position (that is, including turbulence generated accompanying the breakup of a tumble flow in the vicinity of compression TDC).

By using the technique illustrated in FIG. 9, the turbulence of an air-fuel mixture near the ignition timing can be raised at both a time of catalyst warm-up operation and a time of non-catalyst warm-up operation. However, because it is necessary to significantly narrow the opening degree of the intake passage when using this technique that closes the TCV, the pumping loss increases and fuel efficiency deteriorates. It is desirable that the need to raise the turbulence of an air-fuel mixture near the ignition timing at both a time of catalyst warm-up operation and a time of non-catalyst warm-up operation be fulfilled while suppressing an increase in pumping loss.

### [Characteristic Control in First Embodiment]

### (Groove Depth in Piston Crown Surface and Timing for Generating Turbulence)

As a result of extensive studies conducted by the present inventor it was found that by making a groove that is formed in the crown surface of a piston deep, in comparison to a case where the groove is relatively shallow, the timing at which turbulence is generated accompanying the breakup of a tumble flow can be delayed.

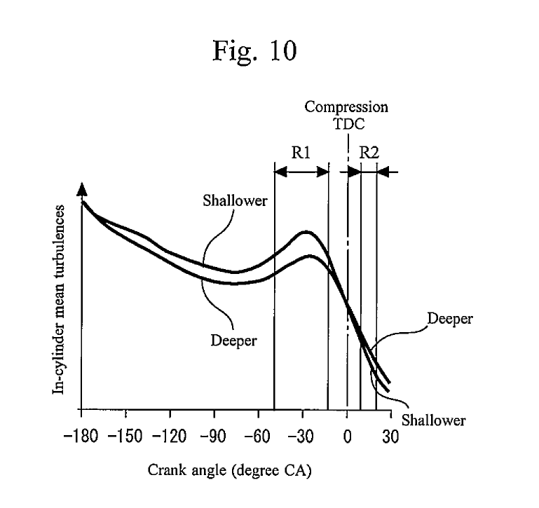

FIG. 10 is a view that represents a relation between a groove depth in a piston crown surface and an in-cylinder mean turbulence. More specifically, FIG. 10 shows results obtained by simulating in-cylinder mean turbulence in accordance with differences in groove depths in the crown surface of pistons in a case of two kinds of pistons in which the depths of grooves that are formed in the crown surface of the respective pistons so as to extend in the aforementioned orthogonal direction D are different from each other. This simulation is based on a comparison under conditions in which tumble flows of equal strength are generated. Based on FIG. 10 it is found that, before compression TDC, turbulence is stronger in the case where the groove is shallow in comparison to the case where the groove is deep, and that this relation is reversed in the vicinity of compression TDC, and after compression TDC the turbulence is stronger in the case of the deep groove compared to the shallow groove.

It is considered that the reason the above-described characteristic is obtained is as follows. That is, when a groove in the crown surface is shallow, because a time at which the breakup of a single tumble flow proceeds due to the ascending piston is early, the time at which turbulence is generated accompanying the breakup of the tumble flow is concentrated in an early stage. In contrast, when the groove in the crown surface is deep, the space that remains for rotation of the tumble flow (in other words, the combustion chamber height) at a crank angle position in the vicinity of compression TDC increases in comparison to when the groove is shallow. Consequently, a time at which the breakup of the tumble flow proceeds is relatively late. As a result, generation of turbulence that accompanies the breakup of the tumble flow is continued until a later stage.

### (Overview of Characteristic Control in First Embodiment)

In the present embodiment, focusing on the findings illustrated in FIG. 10, a configuration is adopted that performs the following control in a case of performing stratified charge combustion utilizing a tumble flow. That is, the hardware configuration that is taken as a premise for this control, as described in the foregoing, includes the piston 12 having the crown surface 12a in which the outer grooves 38 and inner groove 40 that have different depths from each other are formed, and the air flow control valve 22 that is capable of controlling a flow of intake air so that a tumble flow is concentrated at the relatively deep inner groove 40. Furthermore, the air flow control valve 22 is fully opened during non-catalyst warm-up operation and is fully closed during catalyst warm-up operation.

In a case where the air flow control valve 22 is opened fully, as already described referring to FIG. 8, bias does not arise in the flow of intake air at the intake port 16a. Consequently, the intake air flows into the cylinder evenly without inclining towards any one of the two outer grooves 38 and the one inner groove 40. As a result, a tumble flow in this case rotates utilizing all of the two outer grooves 38 and the one inner groove 40. Accordingly, rotation of the tumble flow in this case is regarded as being the same as rotation of a tumble flow that is performed utilizing a single groove having the average groove depth of the two outer grooves 38 and the one inner groove 40.

In contrast, in a case where the air flow control valve 22 is closed fully, as already described with reference to FIG. 8, a bias arises in the flow of intake air at the intake port 16a, and, with respect to the direction of the axis line L1, the intake air flows into the cylinder in such a manner as to concentrate at a site at which the inner groove 40 is provided. As a result, rotation of the tumble flow in this case is performed mainly utilizing the inner groove 40.

The depth of the inner groove 40 is greater than the average groove depth of the two outer grooves 38 and the single inner groove 40. Accordingly, by opening/closing the air flow control valve 22, the characteristic that is based on the finding illustrated in FIG. 10, that is, the characteristic that the timing at which turbulence of an air-fuel mixture is generated changes accompanying a difference in the groove depth in the crown surface, can be utilized irrespective of the fact that a single hardware configuration is used.

Note that, as well as selection of the groove width (groove length in the axis line L1 direction), preferably the depths of the inner groove 40 and outer grooves 38 are also selected so as to satisfy the following requirement. That is, the strength of the turbulence in an air-fuel mixture that is required near the ignition timing both at a time of catalyst warm-up operation and at a time of non-catalyst warm-up operation is ascertained as a necessary value for keeping combustion fluctuations less than or equal to a predetermined permissible value. Accordingly, preferably the depth and width of the inner groove 40 and outer grooves 38, respectively, are selected so that the strength of the turbulence near the ignition timing satisfies a value that is ascertained as described above.

### (Specific Processing in First Embodiment)

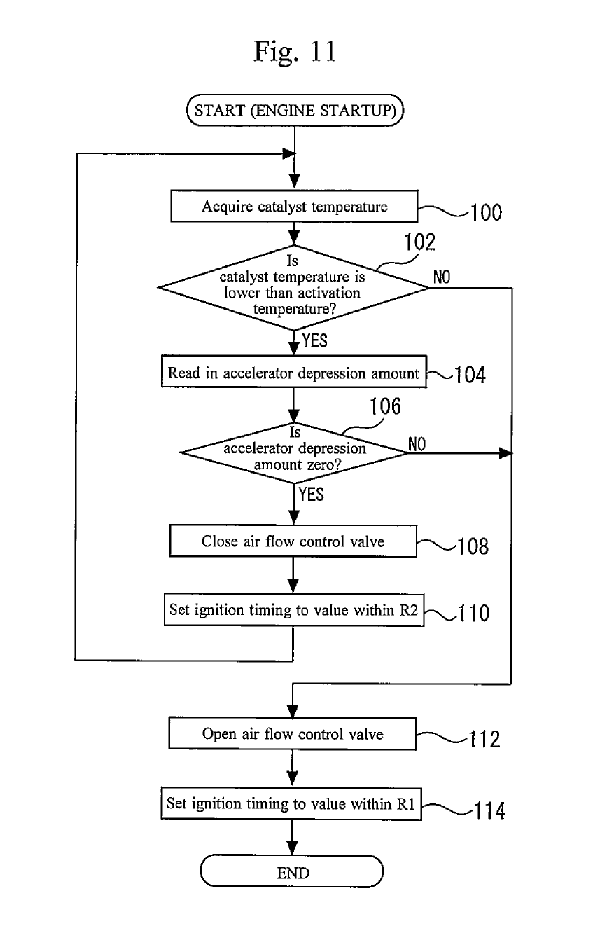

FIG. 11 is a flowchart that illustrates a flow of control according to the first embodiment of the present application. The ECU 36 starts the processing in this flowchart when the internal combustion engine 10 is started up. First, in step 100, the ECU 36 acquires the temperature of the exhaust gas purification catalyst 32. For example, the present acquisition of the catalyst temperature may be performed using a temperature sensor, or may be performed using a predetermined estimation technique. As the estimation technique, a known method can be used that estimates the catalyst temperature based on, for example, the outside air temperature, the immediately preceding exhaust gas temperature and an elapsed time period since the last time that the internal combustion engine 10 stopped.

Next, the ECU 36 proceeds to step 102 to determine whether or not the catalyst temperature is lower than a predetermined activation temperature. The activation temperature is a value that is determined based on the results of unit testing of a catalyst that is performed beforehand.

When the result determined in step 102 is negative, the ECU 36 proceeds to step 112. On the other hand, if the result determined in step 102 is affirmative, that is, when the catalyst temperature is lower than the activation temperature, the ECU 36 proceeds to step 104. In step 104, the ECU 36 uses the accelerator position sensor 37 to read in the accelerator depression amount.

Next, the ECU 36 proceeds to step 106 to determine whether or not the accelerator depression amount is zero. When it is determined as a result that the accelerator depression amount is not zero, that is, when it can be determined that the internal combustion engine 10 is not in an idle state because the accelerator is being depressed, the ECU 36 proceeds to step 112.

In contrast, when the result determined in step 106 is affirmative, that is, when it can be determined that the internal combustion engine 10 is in an idle state, the ECU 36 proceeds to step 108. In step 108, the ECU 36 fully closes the air flow control valve 22. Next, the ECU 36 proceeds to step 110. In step 110, the ignition timing is set so as to become a value within a usage range R2 of the ignition timing during catalyst warm-up operation (for example, a value in the vicinity of 15° CA after compression TDC). That is, an ignition timing that is retarded by a large amount relative to the optimal ignition timing is used.

After executing the processing in step 110, the ECU 36 repeats execution of the processing from step 100 onward at the next timing in a calculation period of the ECU 36. By this means, in a situation in which the catalyst temperature is lower than the activation temperature and the internal combustion engine 10 is in an idle state (that is, a fast idle state), catalyst warm-up control by retardation of the ignition timing is continued in a state in which the air flow control valve 22 is controlled to be fully closed.

The above described catalyst warm-up control is ended when the catalyst temperature reaches the activation temperature during execution of the catalyst warm-up control, or when the accelerator pedal is depressed and the internal combustion engine 10 is no longer in an idle state. In such a case, in step 112, the air flow control valve 22 is controlled to open fully. Next, in step 114, the ignition timing is set so as to become a value within a usage range R1 (for example, 40 to 10° CA before compression TDC) of the ignition timing during non-catalyst warm-up operation. That is, the optimal ignition timing is used as the ignition timing in this case. When the processing in step 114 is executed, the ECU 36 ends the control of the present embodiment according to the flowchart shown in FIG. 11.

### (Advantages of Internal Combustion Engine According to First Embodiment)

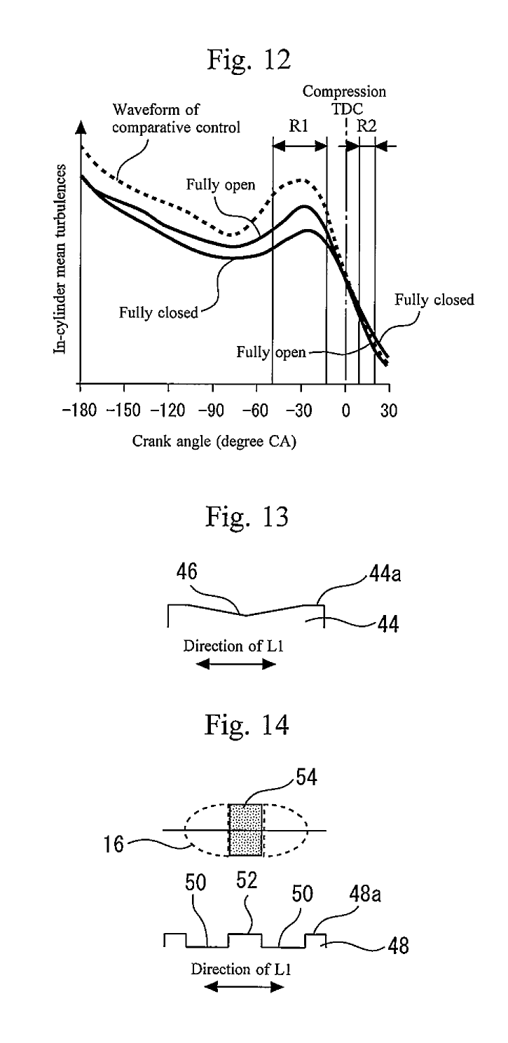

FIG. 12 is a view for describing a characteristic whereby turbulence in an air-fuel mixture that is obtained by the control according to the first embodiment of the present application is generated. According to the control of the air flow control valve 22 of the present embodiment, as shown in FIG. 12, in a case where the air flow control valve 22 is fully opened, at a timing that is before compression TDC (that is, near the ignition timing for a time of non-catalyst warm-up operation), a characteristic is obtained such that the turbulence of the air-fuel mixture becomes stronger in comparison to when the air flow control valve 22 is fully closed. On the other hand, in a case where the air flow control valve 22 is fully closed, at a timing that is after compression TDC (that is, near the ignition timing for a time of catalyst warm-up operation), a characteristic is obtained such that the turbulence of the air-fuel mixture becomes stronger in comparison to when the air flow control valve 22 is fully open. Thus, according to the control in the present embodiment, using a single hardware configuration, turbulence of the air-fuel mixture can be ensured near the ignition timing at each of a time of catalyst warm-up operation and a time of non-catalyst warm-up operation.

Further, a waveform shown by a broken line for comparison in FIG. 12 is a waveform during “comparative control” that is performed taking as an object an internal combustion engine that includes a piston having a single groove that is formed to a depth that corresponds to the average groove depth of the two outer grooves 38 and the one inner groove 40, and also includes a TCV and not the air flow control valve 22. The term “comparative control” used here refers to control that, in the relevant internal combustion engine, strengthens a tumble flow by closing the TCV in order to obtain, near the ignition timing during catalyst warm-up operation, turbulence of a strength that is equal to the strength in a case where the air flow control valve 22 is closed fully. As described above, a concern regarding execution of this kind of control is that pumping loss significantly increases. In contrast, according to the control in the present embodiment, while suppressing such an increase in the pumping loss, turbulence of the air-fuel mixture can be ensured near the ignition timing for each of a time of catalyst warm-up operation and a time of non-catalyst warm-up operation.

Further, with regard to the outer grooves 38 and inner groove 40 formed in the crown surface 12a of the piston 12 of the present embodiment, the inner groove 40 that is the groove located in the center portion of the crown surface 12a in the direction of the axis line L1 is formed to be the deepest of the grooves. The center part is a part at which the longest length of the cylinder bore can be secured when a tumble flow rotates, and is also a part at which the most height of the combustion chamber can be generally secured. That is, in the aforementioned center part, a tumble flow can be caused to rotate on a wide cross-sectional area compared to an edge side in the direction of the axis line L1. Consequently, at the center part, a tumble flow is less likely to be smashed and is liable to be maintained for a long time. In the piston 12 of the present embodiment, a deep part (that is, the inner groove 40) among the grooves in the crown surface 12a corresponds to such a center part. Therefore, a timing at which generation of turbulence is performed accompanying breakup of a tumble flow can be favorably delayed. As a result, strengthening of the turbulence near the ignition timing during catalyst warm-up operation can be facilitated.

### Modifications of First Embodiment

The above first embodiment has been described taking as an example the piston 12 having, in the crown surface 12a, the two outer grooves 38 and the one inner grooves 40 as a concave portion in which, as shown in FIG. 5 and the like, the depth changes in a stepwise manner in the direction of the axis line L1. However, a concave portion that is formed in the crown surface of the piston according to the present application is not limited to the above described shape and, for example, may be a shape as shown in FIG. 13 through FIG. 15 that are described hereunder. Note that FIG. 13 through FIG. 15 are views as seen from the same direction as FIG. 5.

FIG. 13 is a transverse sectional view of a piston 44 for describing a first modification of the concave portion in the present application. In a crown surface 44a of the piston 44 shown in FIG. 13, a groove 46 is formed as the concave portion in the present application. The groove 46 is different from the concave portion of the first embodiment formed by a combination of the inner groove 40 and the outer grooves 38, in the respect that the groove 46 is formed so that the depth thereof continuously changes in the direction of the axis line L1. More specifically, the groove 46 is formed so as to be deepest at the center portion of the crown surface 44a in the direction of the axis line L1. Accordingly, in a case where bias of a flow of intake air inside the intake port is controlled taking as an object the piston 44 that has the groove 46, similarly to the first embodiment, it is sufficient to adopt a configuration that uses the air flow control valve 22 in which the non-blocking portion 22c is provided at the center portion in the direction of the axis line L1, and in which the air flow control valve 22 is fully closed during catalyst warm-up operation.

FIG. 14 is a transverse sectional view of a piston 48 for describing a second modification of the concave portion in the present application. In a crown surface 48a of the piston 48 shown in FIG. 14, two outer grooves 50 and one inner groove 52 are formed as the concave portion in the present application. According to this example, contrary to the example in the first embodiment, the relatively deep outer grooves 50 are formed adjacent to both sides of the relatively shallow inner groove 52 in the direction of the axis line L1. Further, in this example the internal combustion engine includes an air flow control valve 54. The air flow control valve 54 that is schematically represented in FIG. 14 is in a fully closed state. The air flow control valve 54 is formed in correspondence with the setting of the shape of the outer grooves 50 and inner groove 52 so that, when the air flow control valve 54 is fully closed, a part of the intake passage 16 corresponding to the inner groove 52 that is the shallow groove is blocked off and a part of the intake passage 16 corresponding to the deep outer grooves 50 can be left open. According to this configuration, by fully closing the air flow control valve 54, a bias can be generated in a flow of intake air inside the intake port 16a so that the intake air is guided towards the relatively deep outer grooves 50 in the direction of the axis line L1.

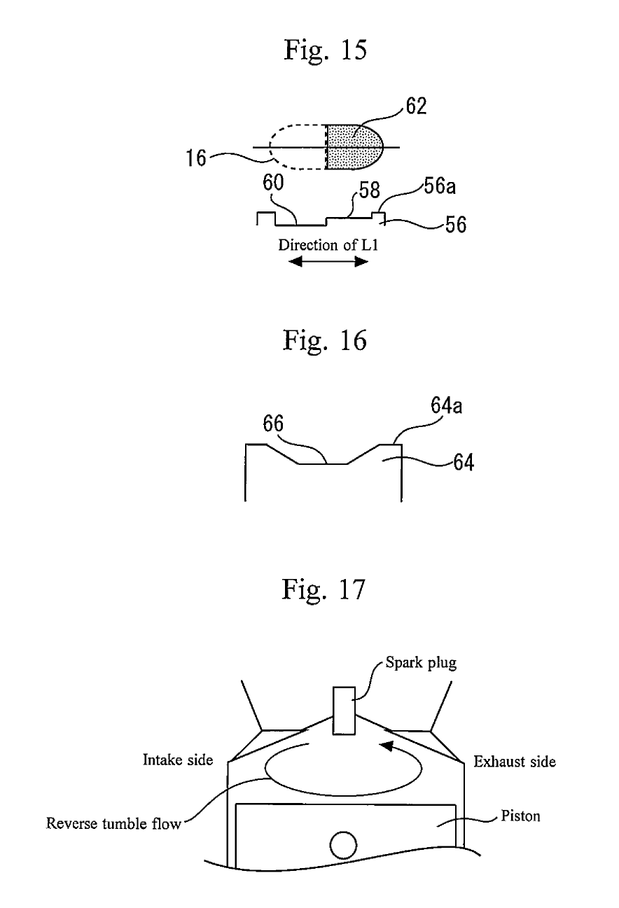

FIG. 15 is a transverse sectional view of a piston 56 for describing a third modification of the concave portion in the present application. In a crown surface 56a of the piston 56 shown in FIG. 15, a shallow groove 58 and a deep groove 60 are formed as the concave portion in the present application. More specifically, the crown surface 56a includes a concave portion in which higher and lower parts are provided with respect to the depth by means of the shallow groove 58 and the deep groove 60 in the direction of the axis line L1. Further, in this example, the internal combustion engine includes an air flow control valve 62. The air flow control valve 62 that is schematically represented in FIG. 15 is in a fully closed state. The air flow control valve 62 is formed in correspondence with the setting of the shape of the shallow groove 58 and the deep groove 60 so that, when the air flow control valve 62 is fully closed, a part of the intake passage 16 corresponding to the shallow groove 58 is blocked off and a part of the intake passage 16 corresponding to the deep groove 60 can be left open. According to this configuration, by fully closing the air flow control valve 62, a bias can be generated in a flow of intake air inside the intake port 16a so that the intake air is guided towards the deep groove 60, which is the relatively deep groove in the direction of the axis line L1.

Further, in the above-described first embodiment, as shown in FIG. 6, the inner groove 40 and outer groove 38 are provided that are formed as grooves in which the respective curvatures are constant. However, the concave portion in the present application is not limited to a concave portion having a cross-sectional shape in which the curvature is made constant. That is, the concave portion may be, for example, a concave portion having a cross-sectional shape in which the curvature changes stepwise or continuously. Further, for example, a cross-sectional shape as illustrated in FIG. 16 that is described hereunder may also be used. Note that FIG. 16 is a view as seen from the same direction as FIG. 6.

FIG. 16 is a transverse sectional view of a piston 64 for describing a fourth modification of the concave portion in the present application. In a crown surface 64a of the piston 64 shown in FIG. 16, a groove 66 is formed as the concave portion in the present application. The cross-sectional shape of the concave portion in the present application may also be a shape that is obtained by combining a plurality of straight lines, as in the groove 66 illustrated in FIG. 16.

Further, in the above-described first embodiment a configuration is adopted that fully closes the air flow control valve 22 at a time of idle operation in which catalyst warm-up control is performed by retardation of the ignition timing. However, as long as the operation is performed in a state in which the ignition timing is retarded relative to the optimal ignition timing, a time of stratified charge combustion operation that is taken as an object for generating a bias in a flow of intake air inside an intake port by means of a bias flow generation apparatus in the present application is not limited to a time of idle operation in which catalyst warm-up control is performed.

Further, in the above-described first embodiment, the fuel injection when performing stratified charge combustion is described taking, as an example, divided injection using the in-cylinder injection valve 26. However, an internal combustion engine that is an object of the present application may be an internal combustion engine that includes, in addition to the in-cylinder injection valve, a port injection valve that injects fuel into an intake port, and that performs an initial fuel injection that is the main fuel injection using the port injection valve, and uses the in-cylinder injection valve to perform injection of a small amount of fuel that is required for stratification.

Furthermore, the foregoing first embodiment has been described taking a forward tumble flow that ascends on the intake side and descends on the exhaust side as an example of a tumble flow that is generated inside the combustion chamber 14. However, a tumble flow to which the present application can be applied is not limited thereto. FIG. 17 is a view that illustrates the manner in which a reverse tumble flow that descends on the intake side and ascends on the exhaust side is generated inside the combustion chamber 14. As shown in FIG. 17, the present application can also be applied to an internal combustion engine in which a reverse tumble flow is generated inside a cylinder.

Note that, in the above described first embodiment, the air flow control valve 22 and the ECU 36 correspond to “bias flow generation apparatus” according to the present application.

1. An internal combustion engine in which a tumble flow is generated inside a combustion chamber, comprising:
a spark plug arranged in an upper wall face of the combustion chamber;
an in-cylinder injection valve configured, when stratified charge combustion operation is performed, to inject fuel into the combustion chamber so that a fuel spray is carried to a periphery of the spark plug by a tumble flow;
a piston having, in a crown surface thereof, a concave portion that is formed so as to extend in an orthogonal direction to an axis line of a piston pin hole and so that a depth of the concave portion changes in a direction of the axis line; and
a bias flow generation apparatus configured, in a case where stratified charge combustion operation is performed in a state in which an ignition timing is retarded relative to an optimal ignition timing, to generate a bias in a flow of intake air inside an intake port so that intake air is guided towards a part at which the depth is relatively deep in the direction of the axis line inside the concave portion.

2. The internal combustion engine according to claim 1,
wherein the concave portion is formed so as to be deepest at a center portion of the crown surface in the direction of the axis line.

3. The internal combustion engine according to claim 1,
wherein the bias flow generation apparatus includes an air flow control valve that is configured, when in a closed state, to generate a bias in a flow of intake air inside the intake port so that intake air is guided towards the part of the concave portion, and
wherein the bias flow generation apparatus is configured to close the air flow control valve in a case where stratified charge combustion operation is performed in a state in which an ignition timing is retarded relative to an optimal ignition timing, and to open the air flow control valve in a case where stratified charge combustion operation is performed in a state in which an ignition timing is controlled to an optimal ignition timing.
